(19) United States
(12) Patent Application Publication
(10) Pub. No.: US 2003/0098581 A1
(43) Pub. Date: May 29, 2003

(54) Mailable articles

(76) Inventors: Meg M. Cundiff, Mission, KS (US); Sandy M. Koeser, Kansas City, MO (US); Anne Langley Thurlow, Leawood, KS (US); Randall S. Knipp, Kansas City, MO (US)

Correspondence Address: GREG H. GARDELLA, Fish & Richardson P.C., P.A., 60 South Sixth Street, Suite 3300, Minneapolis, MN, 55402, US

(21) Appl. No.: 10/299,188

(22) Filed: Nov. 19, 2002

Related U.S. Application Data
(60) Provisional application No. 60/331,696, filed on Nov. 19, 2001.

(51) Int. Cl. B42D 15/00

(52) U.S. Cl. 283/116

(57) ABSTRACT

In certain embodiments, a mailable greeting article can include a three dimensional but generally planar construction, indicia demarking areas for receiving a greeting and an address, a pre-printed postage indicium, and a durable construction adapted to withstand shipment via a postal carrier without the use of an envelope. Preferred constructions can be purchased, readily inscribed with an address and a greeting on an external surface, and deposited with the postal service without the need to determine or purchase special postage.

### CROSS-REFERENCE TO RELATED APPLICATION

This application is a continuation application of co-pending U.S. provisional application Serial No. 60/331,696, filed Nov. 19, 2001 by Cundiff et al., entitled “Mailable Article,” which is incorporated herein by reference in its entirety.

### BACKGROUND

Greeting cards have historically been designed to be delivered either by hand or mail. Accordingly, greeting cards have been adapted for deployment inside an envelope, which enables a consumer to deliver the greeting by mail if desired.

The use of envelopes imposes certain limitations on the design of greeting cards. First, the envelope obscures the decorative elements which are generally present on the greeting card. Second, envelopes usually lack any significant decorative elements of their own; rather, they are constructed of monochromatic paper, in part to facilitate envelope manufacturing and in part to ease the task of locating and reading the address. The envelope thus can detract from the overall initial impression appearance created by the greeting article. Third, the use of an envelope constrains the design and configuration of the greeting card. Typically mailable greeting articles must have a flat, thin, planar construction in order to comply with postal regulations and to ensure that the article and envelope will appear presentable upon receipt by the addressee.

Delivery of greeting cards without envelopes has been attempted, for instance, through the use of postcard formats. However, postcard designs are subject to strict postal regulations concerning their dimensions and weight. If weight or dimensions vary from those specified by the postal regulations, the required postage increases, giving rise to a likelihood that consumers will fail to place the correct postage on the article. In order to obviate the foregoing concerns, postcard-style greeting cards have had a simple, thin, planar construction. Furthermore, such postcards are generally constructed of paper, which tends to be damaged and disfigured during shipment.

Departure from such greeting card constructions presents several challenges. First, creating a three-dimensional greeting article adapted to be mailed without an envelope requires observance of various postal regulations concerning dimensions, weight, and the like. Second, the three dimensional construction must be made durable enough to withstand shipment without discernable wear. Third, the article should permit easy transcription of a greeting and an address prior to shipment. Fourth, because three dimensional mailers will often exceed the weight and/or dimension regulations for regular postage, consumers may have to visit the post office to determine and purchase proper postage.

### SUMMARY

In certain embodiments, a mailable greeting article can include a three dimensional but generally planar mailer, indicia demarking areas for receiving a greeting and an address, a pre-printed postage indicium, and a durable construction adapted to withstand shipment via a postal carrier without the use of an envelope. Preferred constructions can be purchased, readily inscribed with an address and a greeting on an external surface, and deposited with the postal service without the need to determine or purchase special postage.

A preferred process for making mailable greeting articles can include providing a three dimensional mailer constructed of a plurality of distinct structural and decorative elements and having indicia for a greeting portion and an address portion, weighing at least an exemplar of the article, determining appropriate postage for the article, and pre-printing a plurality of such articles with markings indicating that postage has been pre-paid.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1A and 1B are plan views of reverse sides of a mailable greeting article according to a first embodiment;

FIGS. 2A and 2B are plan views of reverse sides of a mailable greeting article according to a second embodiment;

FIGS. 3A and 3B are plan views of reverse sides of a mailable greeting article according to a third embodiment;

FIGS. 4A and 4B are plan views of reverse sides of a mailable greeting article according to a fourth embodiment;

FIGS. 5A and 5B are plan views of reverse sides of a mailable greeting article according to a fifth embodiment;

FIGS. 6A and 6B are plan views of reverse sides of a mailable greeting article according to a sixth embodiment;

FIGS. 7A and 7B are plan views of reverse sides of a mailable greeting article according to a seventh embodiment;

FIGS. 8A and 8B are plan views of reverse sides of a mailable greeting article according to a eighth embodiment;

FIGS. 9A and 9B are plan views of reverse sides of a mailable greeting article according to a ninth embodiment;

FIGS. 10A and 10B are plan views of reverse sides of a mailable greeting article according to a tenth embodiment;

FIGS. 11A and 11B are plan views of reverse sides of a mailable greeting article according to a eleventh embodiment;

FIGS. 12A and 12B are plan views of reverse sides of a mailable greeting article according to a twelfth embodiment; and

FIGS. 13A and 13B are plan views of reverse sides of a mailable greeting article according to a thirteenth embodiment.

Like reference symbols in the various drawings indicate like elements.

### DETAILED DESCRIPTION OF ILLUSTRATIVE EMBODIMENTS

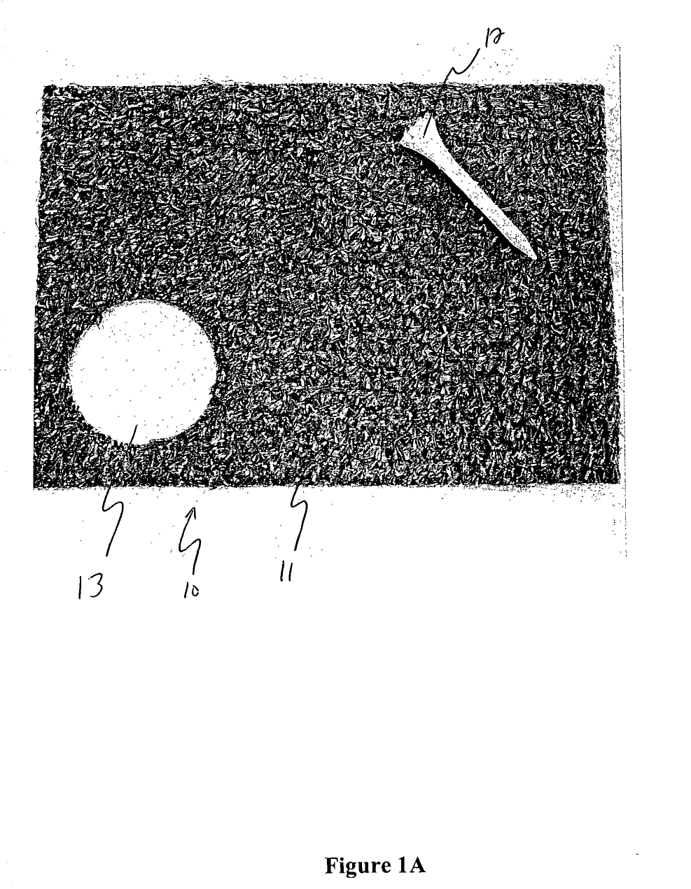

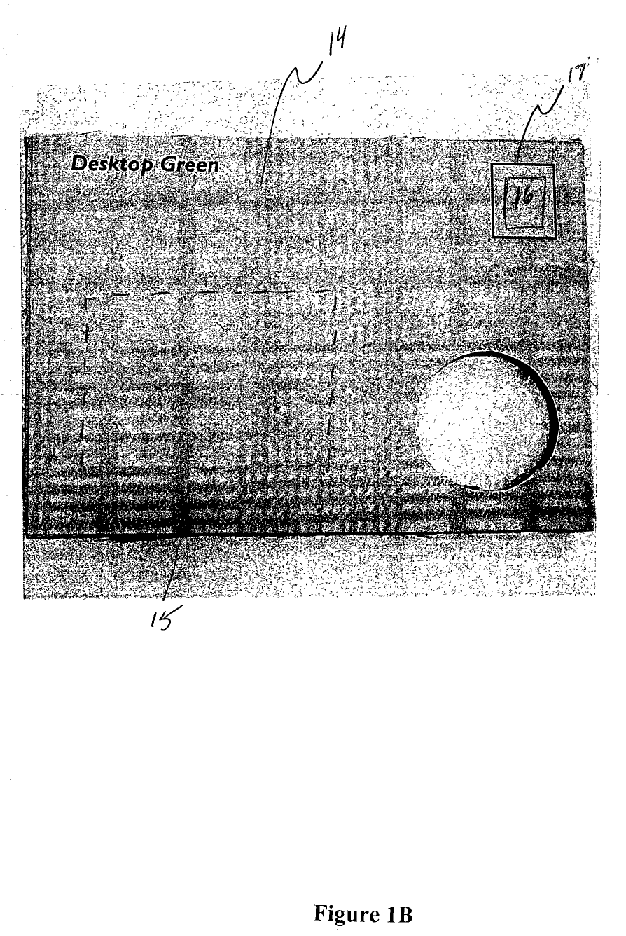

FIGS. 1A and 1B depict reverse sides of a mailer 10 of a first embodiment. One side 11 is comprised of synthetic turf such as Astroturf™ and has a golf tee 12 glued thereto. Die-cut out of the turf is a hole 13 that simulates a hole on a golf green. The reverse side 14 is comprised of a cardstock, polymeric, or other suitable backing material and includes a designated area in which postage may be placed. The recipient address and a greeting may be placed elsewhere on the backing surface. Printed lines 15 or the like can be used to designate the address and greeting areas. The article can have a thickness of about ⅛ to ¼ inch. Given the article's weight, the postage required exceeds that needed to mail a standard 1 oz. envelope. Accordingly, the article may advantageously be weighed during production, after which either a printed indication of the required postage or a pre-paid postage indicator 16 is placed in a designated postage area 17. The mailable article thus serves as a unique and novel greeting product. It is neither a postcard nor an envelope that contains a greeting card. It is a greeting article having a mass and weight greater than a postcard, yet the article can be mailed without an envelope.

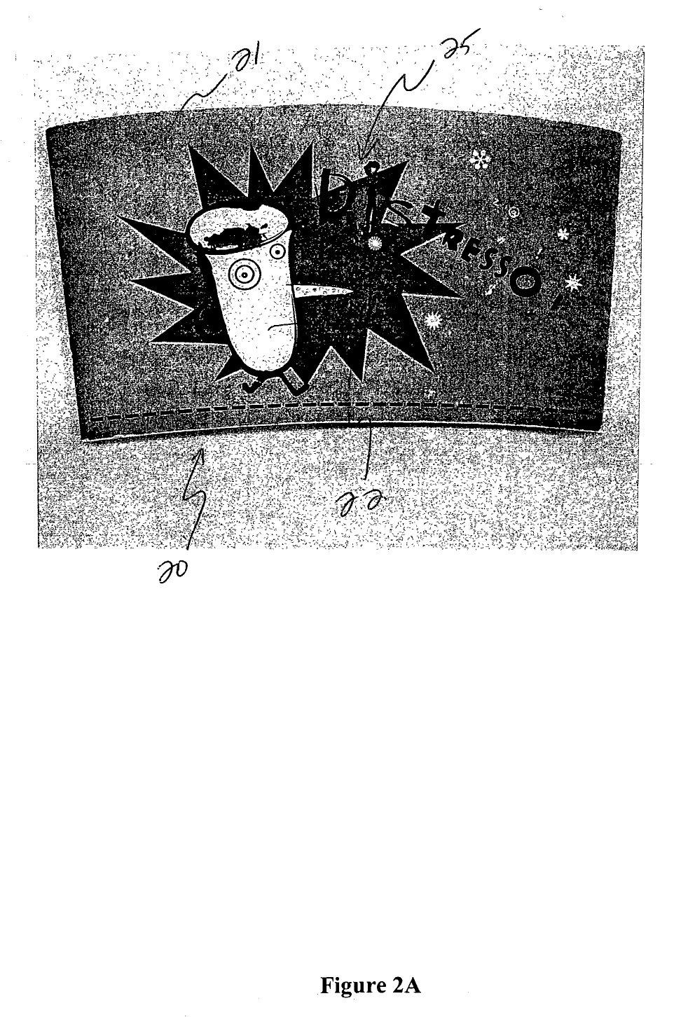

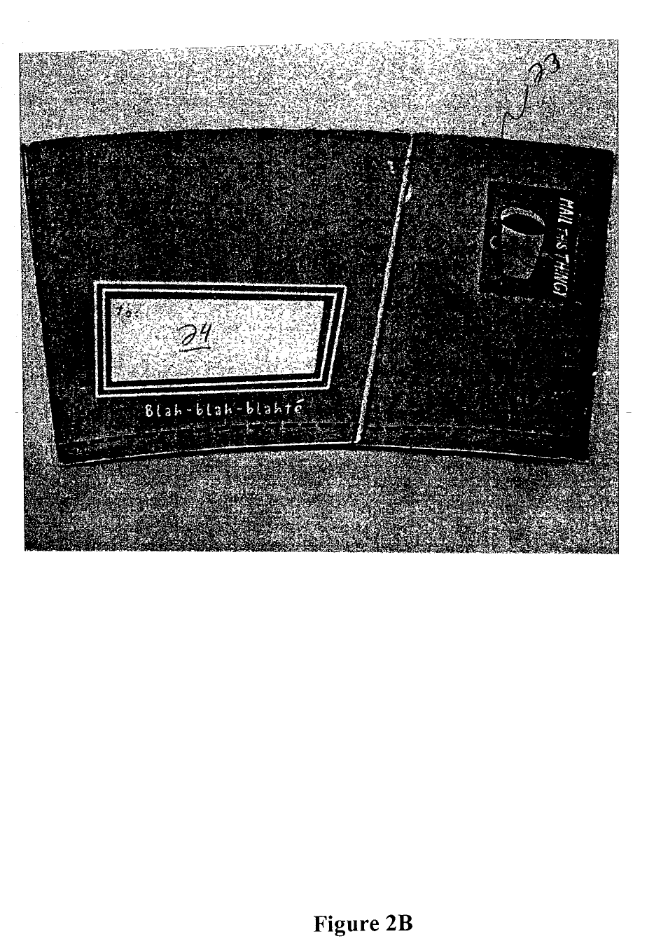

FIGS. 2A and 2B depict front and reverse sides of a mailable greeting article 20 in the form of a cardboard collar 21 such as those typically offered by gourmet coffee bars to insulate a standard paper coffee cup. It is comprised of corrugated cardboard. On one side is printed an ornamental design and/or message 22. The reverse side includes a designated postal area 23 and address area 24. Optionally, a designated greeting area 25 may be disposed on either side of the article. The recipient can use the article as a coffee collar after receiving the article and reading any message or greeting disposed thereon. Like the article of FIGS. 1A and 1B, the article is neither a postcard nor an envelope that contains a greeting card. It is a greeting article having dimensions and construction different than a postcard, yet the article can be mailed without an envelope. The article may advantageously be weighed during production, after which either a printed indication of the required postage or a prepaid postage indicator is placed in a designated postage area.

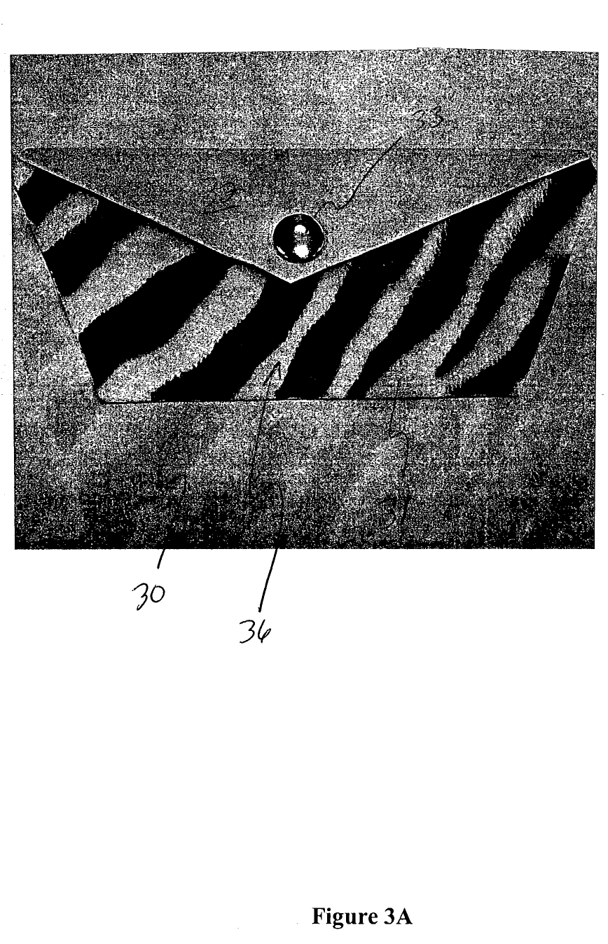

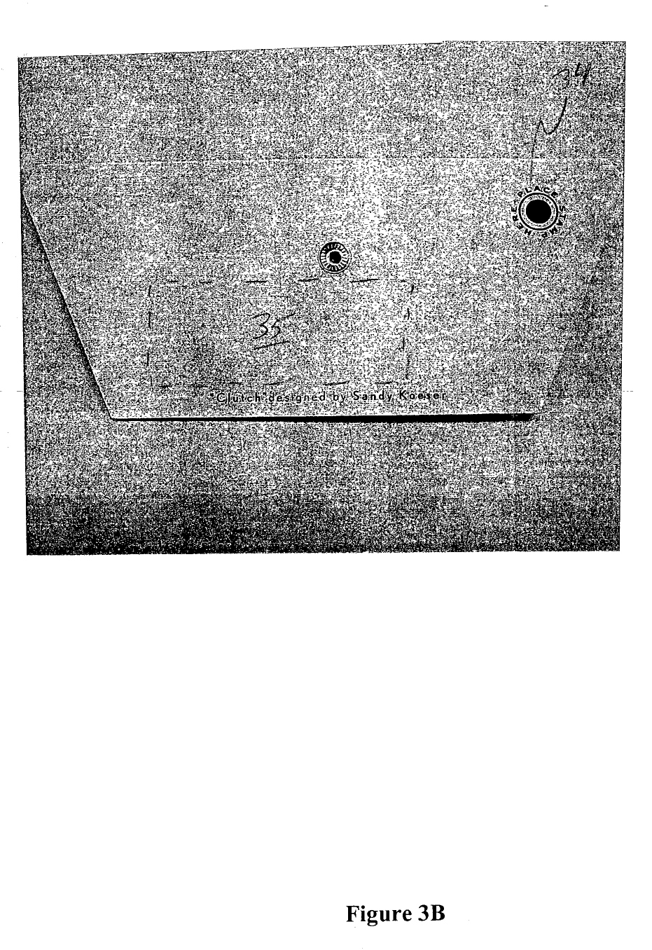

FIGS. 3A and 3B depict front and reverse sides of a mailable greeting article 30 in the form of a zebra-print faux purse. It is comprised of cardstock panels and synthetic printed fabric 31 or synthetic fur bearing a zebra-like pattern. Optionally, polymeric backing material can be used in lieu of cardstock. Overlapping the printed fabric or synthetic fur panel is another panel 32 cut in a triangular shape having one part of a snap fastener button 33 disposed therein. A cooperating snap fastener button mechanism is disposed in the fabric or fur panel. The reverse side includes a designated postal area 34 and optionally includes an address area 35 and greeting area 36 designated by score lines, printed lines or the like. In this embodiment, the fabric and fur panel is integral, and does not define an inner pouch that is exposed by lifting the triangular flap. Optionally, however, such a construction may be advantageously implemented. The article's thickness is between about ¼ inch and ⅛ inch. As the foregoing two embodiments, the article 30 is a greeting article having dimensions and construction different than a postcard, yet the article can be mailed without an envelope. This article, like articles 10 and 20, may advantageously be weighed during production, after which either a printed indication of the required postage or a pre-paid postage indicator is placed in a designated postage area.

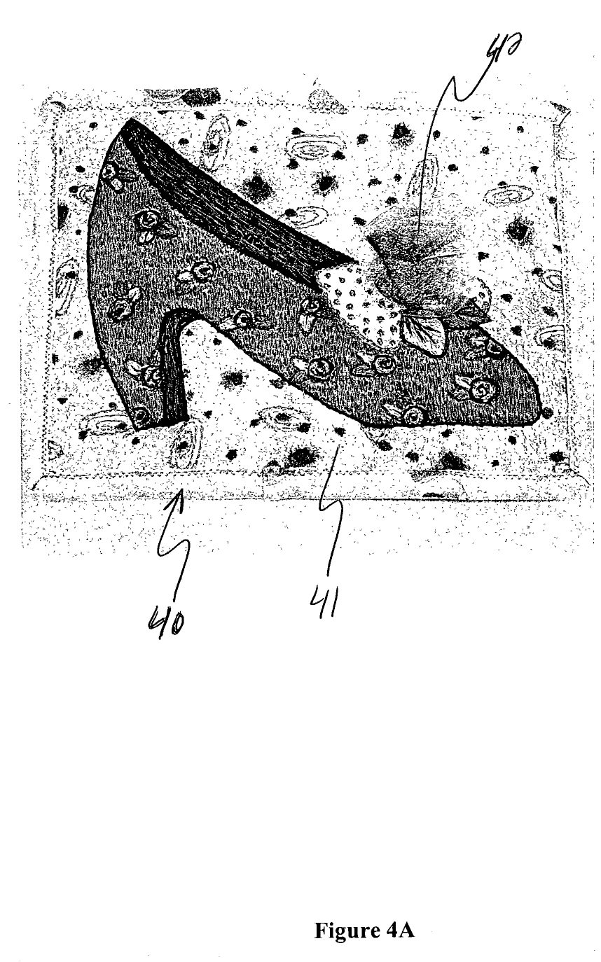

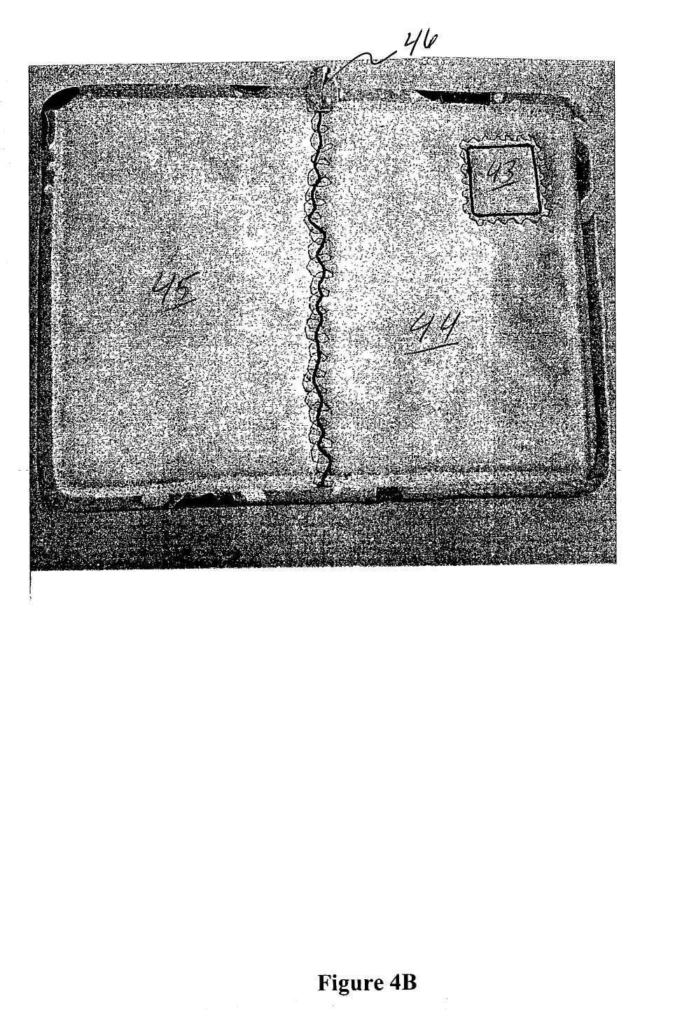

FIGS. 4A and 4B depict front and reverse sides of a mailable greeting article 40 in the form of a hot pad. The article is comprised of fabric exterior 41 and a synthetic foam or padded interior. A carnation-type bow 42 is sewn onto the article at the center of the printed bow. The reverse side includes a designated postal area 43 and optionally includes an address area 44 and greeting area 45 designated by score lines, printed lines, stitch lines or the like. Also disposed on the article is a fabric loop 46 for use in hanging the article on a hook or similar structure. The article's thickness is between about ¼ inch and ⅛ inch. The article 40 is adapted to be weighed during production, printed with a pre-paid postage indicator, and mailed without an envelope.

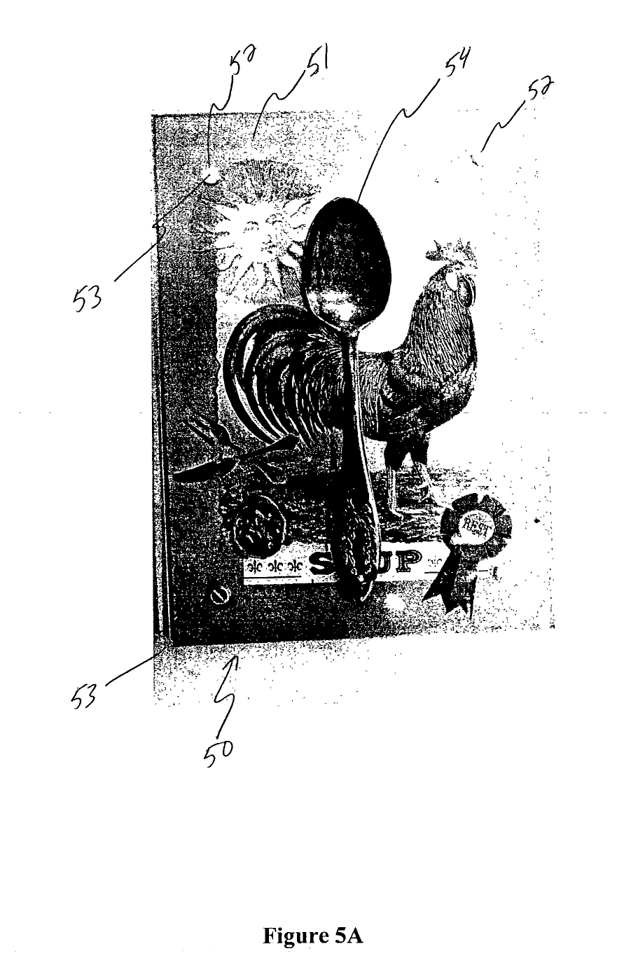

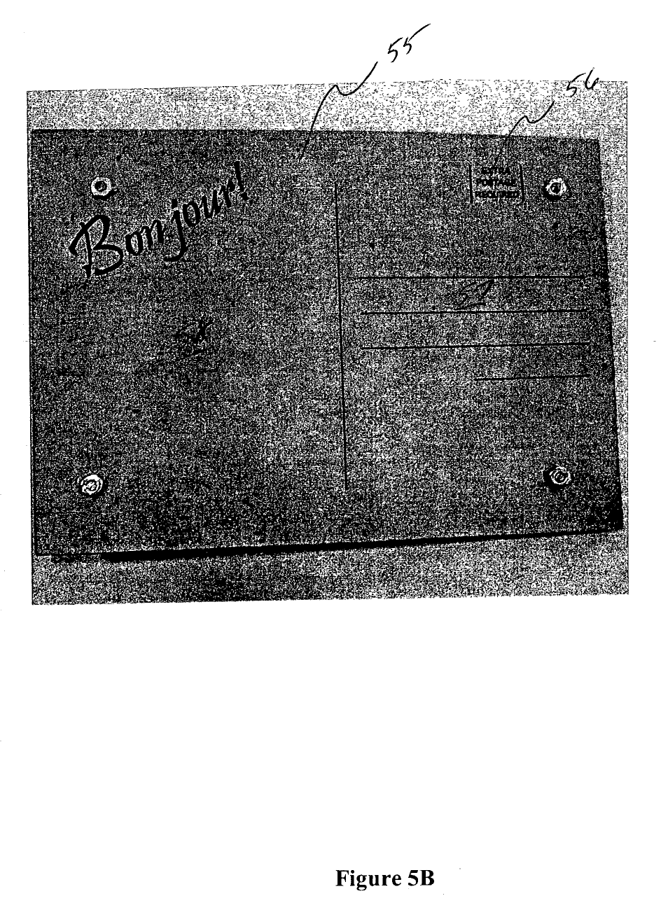

FIGS. 5A and 5B depict front and reverse sides of a mailable greeting article 50 in the form of a composite article with a clear hard plastic cover 51. A clear polymeric material such as Plexiglass has four holes 52 drilled therein. Bolts 53 secure the hard plastic cover a backing material (see FIG. 5B), which can be polymeric, paper, wood, or the like. Various ornamental members may be disposed between the cover and the backing, such as the depicted spoon 54. Optionally, such ornamental members can be molded into the plastic such that the plastic cover fits substantially flush against the backing material. Alternately, paper can be stamped with foil and embossed and thereafter adhered to the inner or outer surface of the hard plastic cover, thereby supporting and protecting the embossed foil. The reverse side 55 includes a designated postal area 56, address area 57 and greeting area 58. Optionally, score lines or other structures can be used to designate these areas. The article's thickness is between about ¼ inch and ⅛ inch. This embodiment can likewise be weighed, marked with pre-paid postage indicia, and mailed without an envelope.

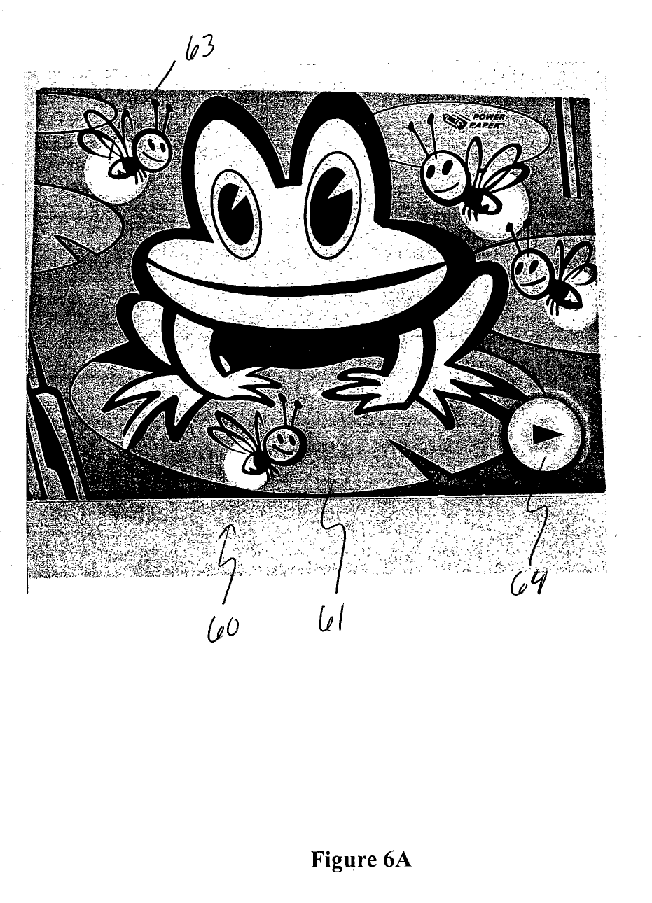

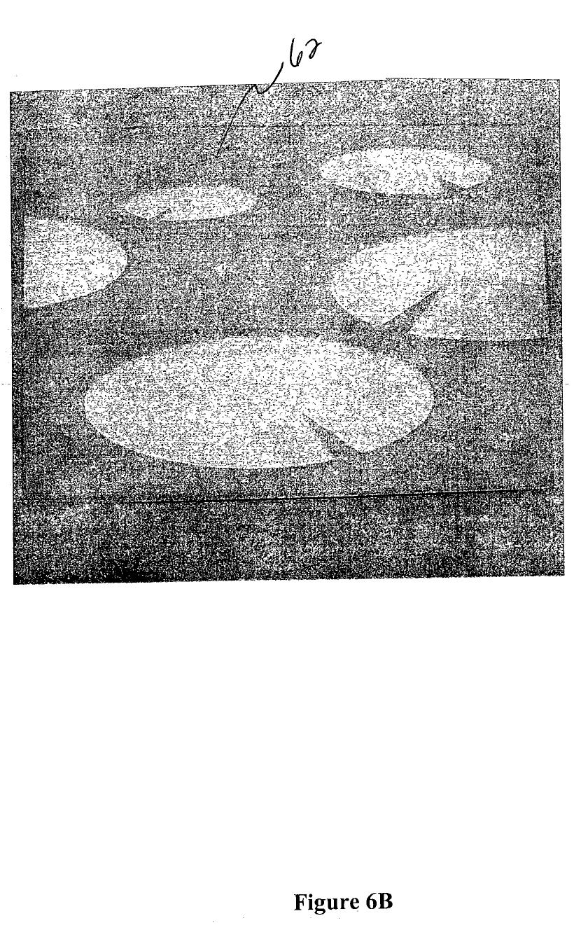

The same operative principles discussed above apply to the mailable articles depicted in FIGS. 6A-13B. Accordingly, the embodiments of FIGS. 6A-13B will be discussed in an abbreviated fashion below.

FIGS. 6A and 6B depict a greeting article 60 having a thickness of about 1/32 to 1/16 inch and comprised of a printed battery circuit (not shown) sandwiched between two pieces of printed, die-cut cardstock 61,62. The top piece of cardstock 61, shown in FIG. 6A, is die cut in the region 63 surrounding the fireflies' tails. This permits the bottom piece of cardstock to show through in region 63. The printed circuit includes a plurality of LED's disposed beneath the fireflies' tails and a switch and timing circuit to activate the LED's in a predetermined pattern when pressure is applied to a switch disposed beneath the printed triangle “button” 64 (which is surrounded by printed circles). The flexible printed circuit is available from Power Paper Ltd, Kibbutz Einat, Israel 49910.

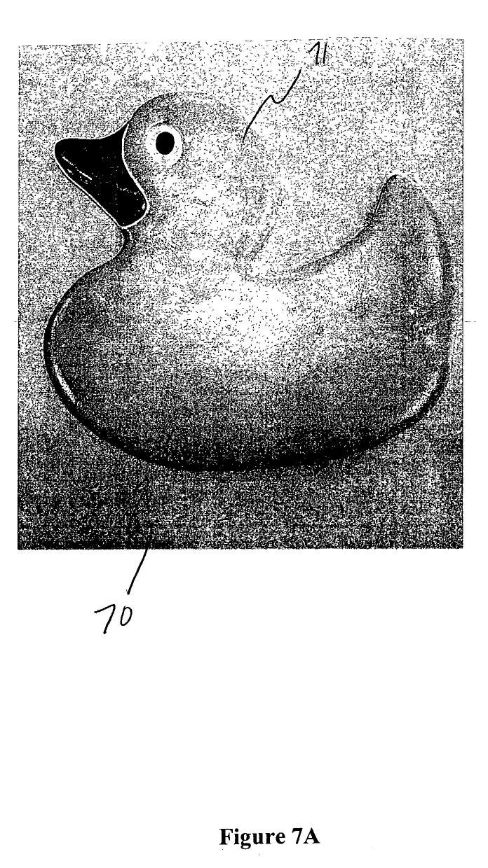

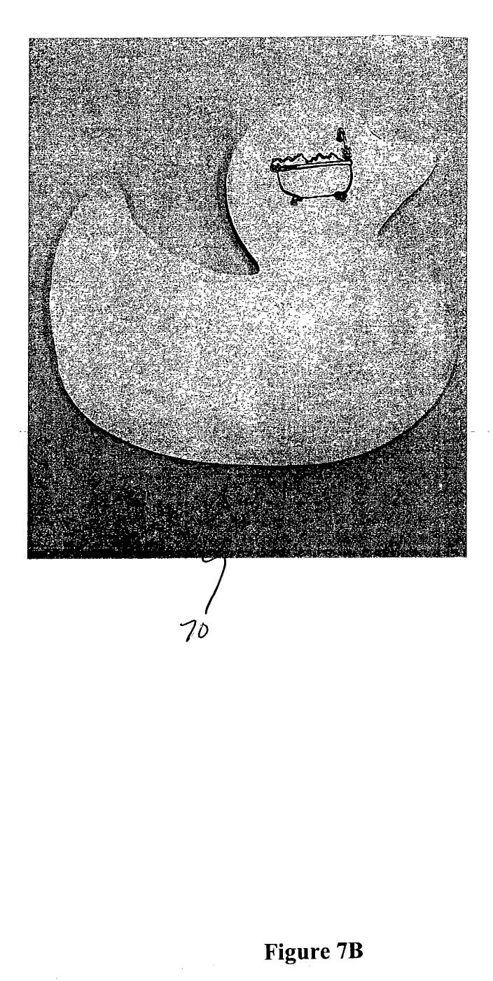

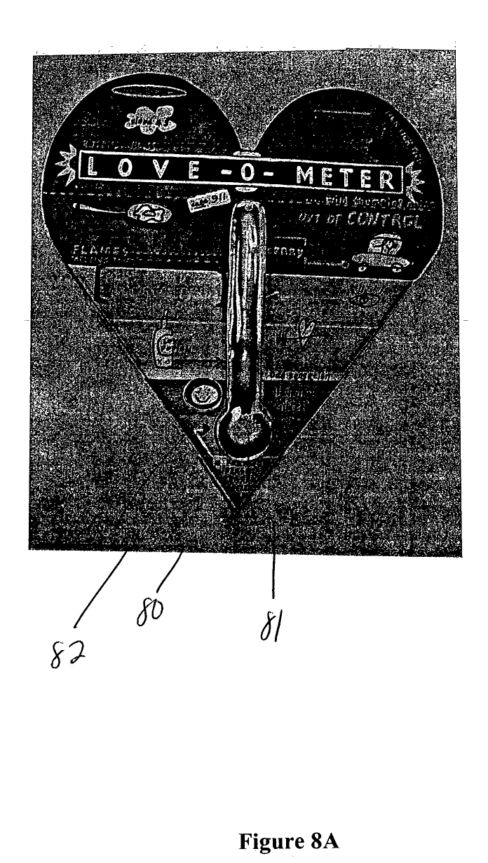

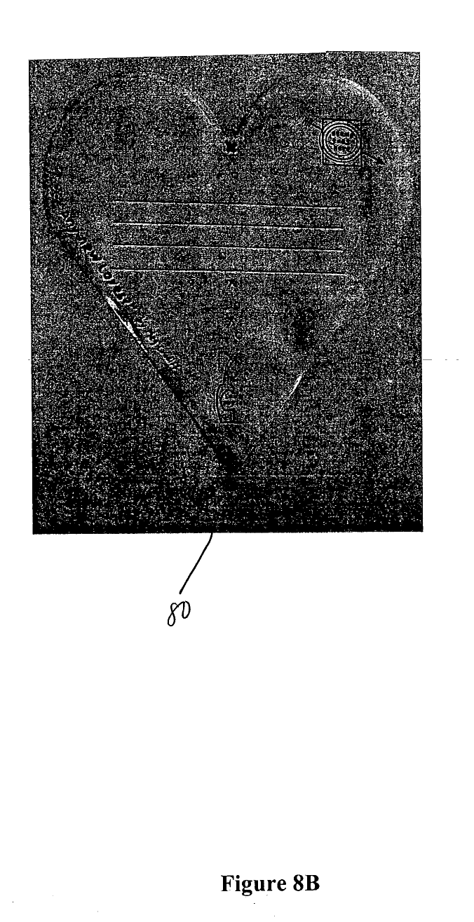

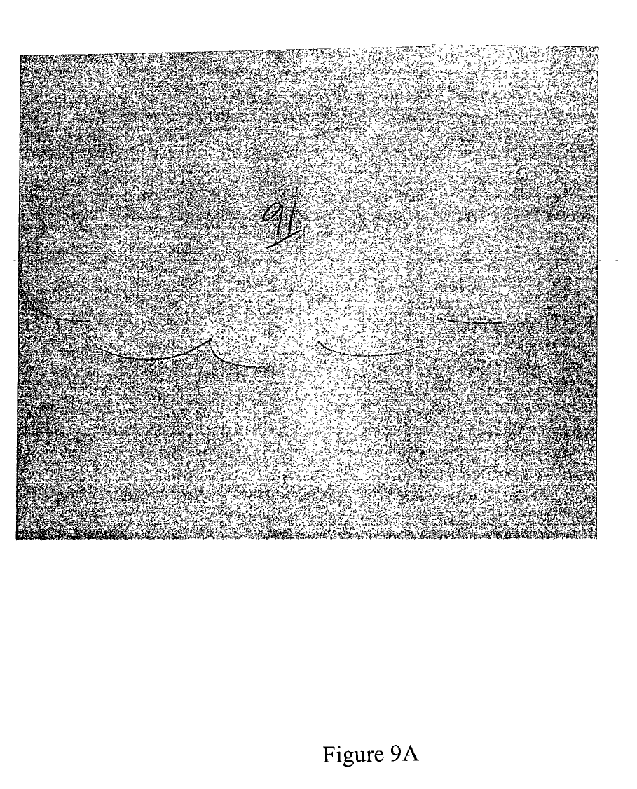

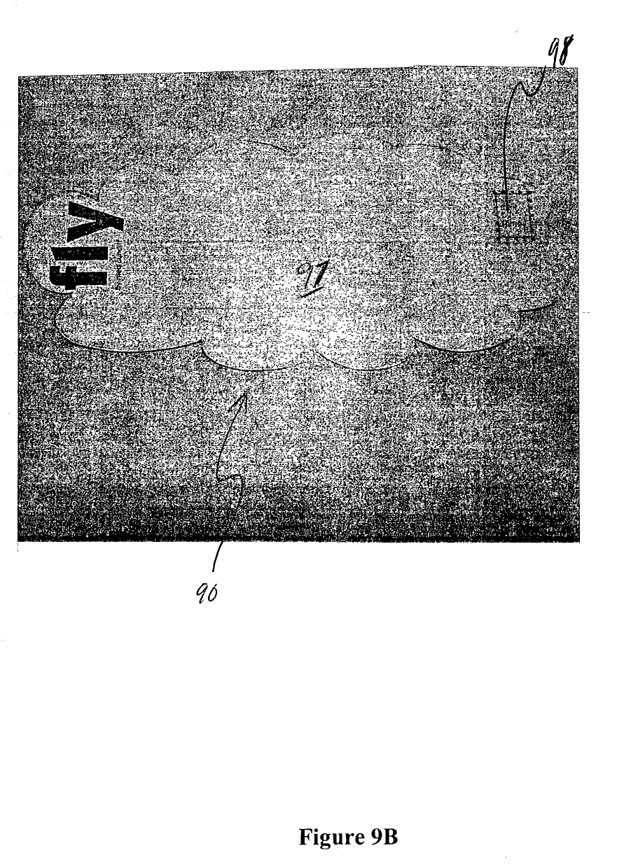

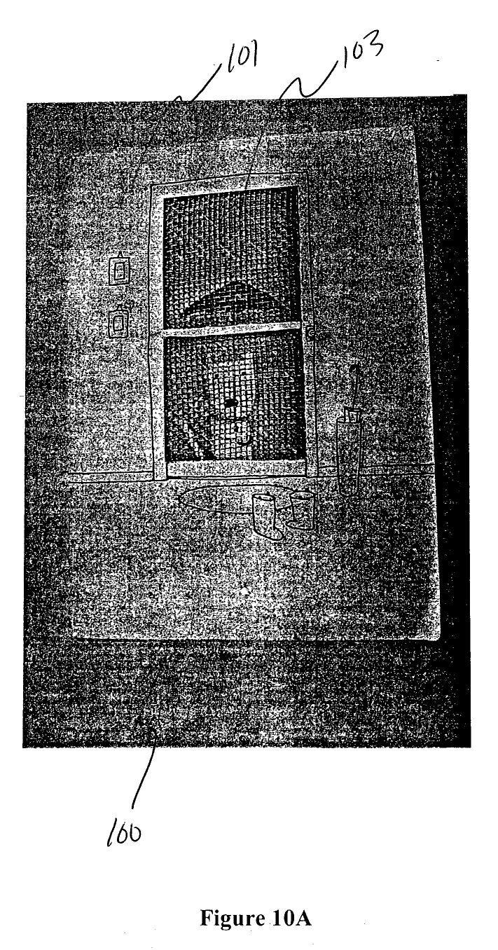

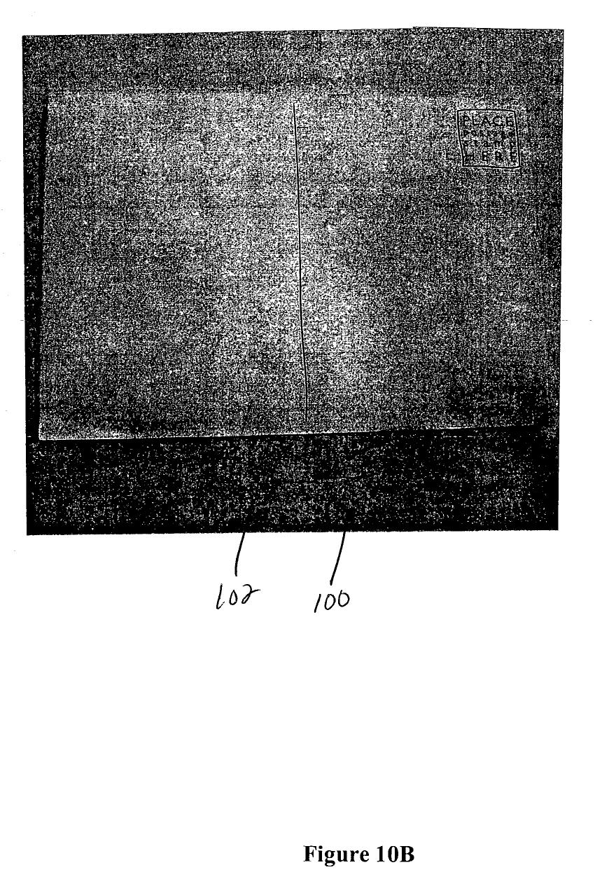

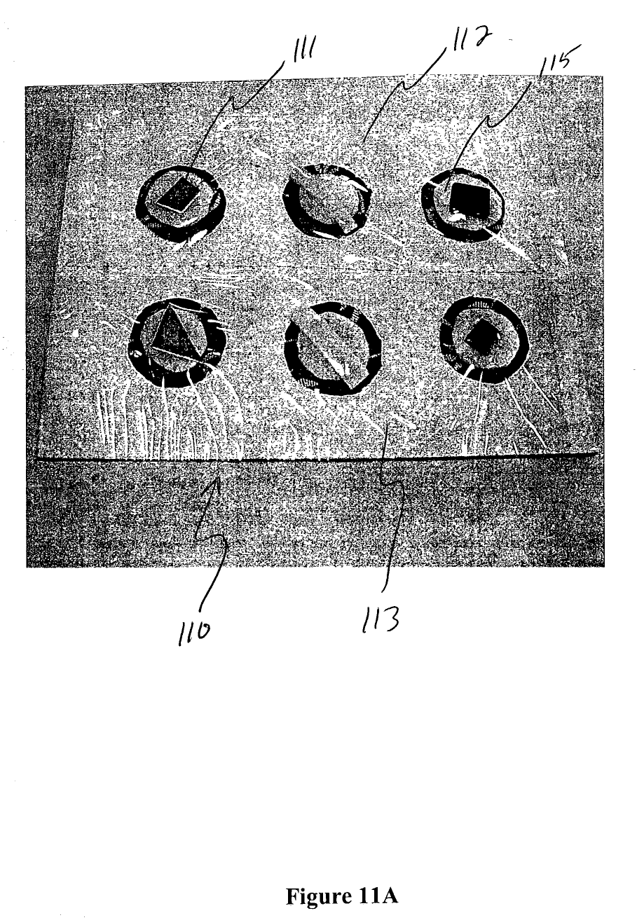

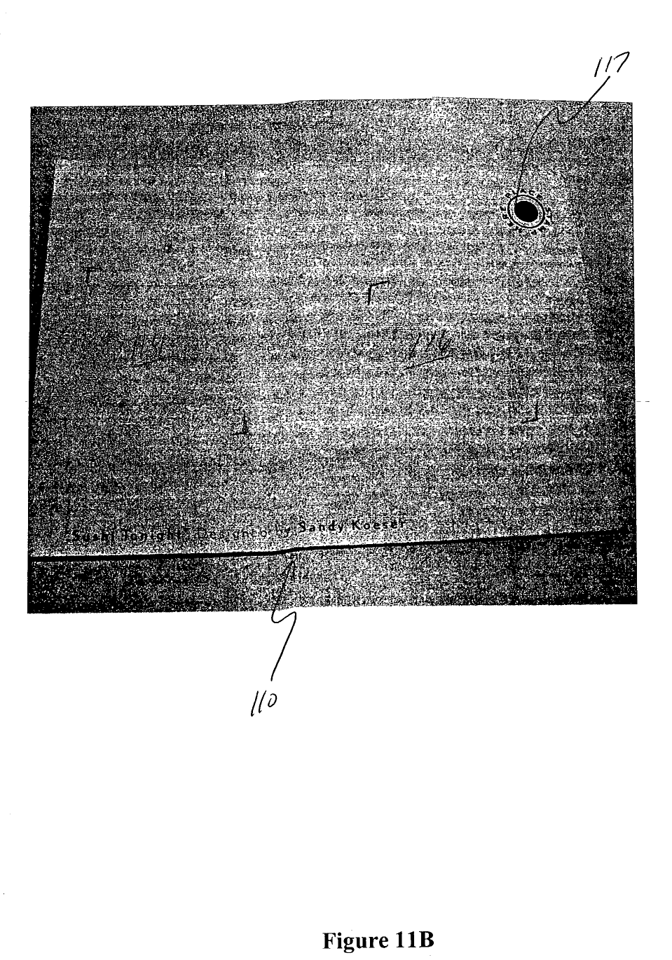

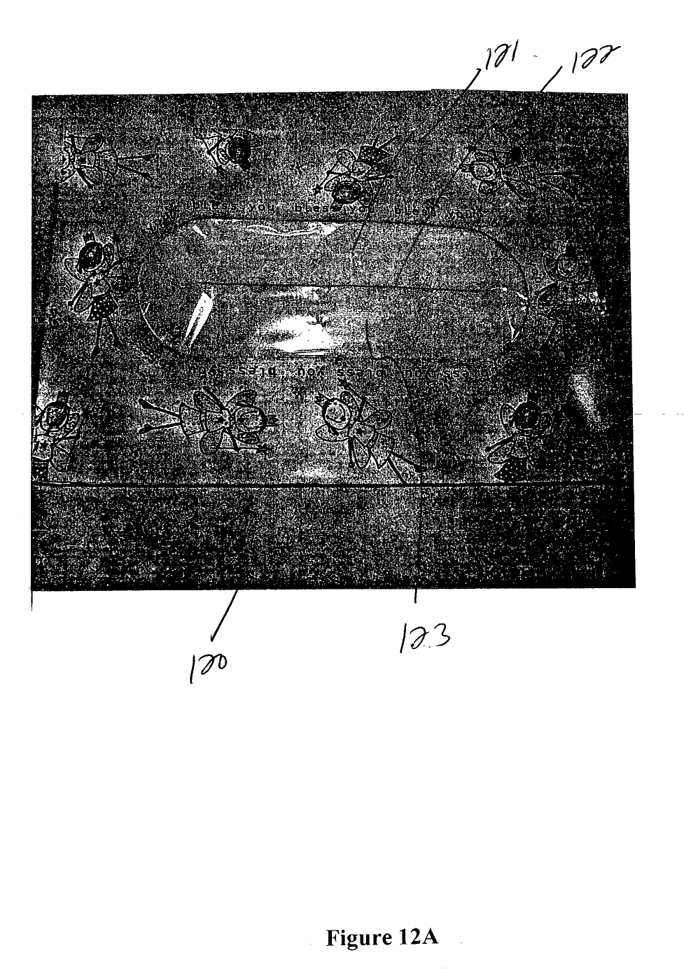

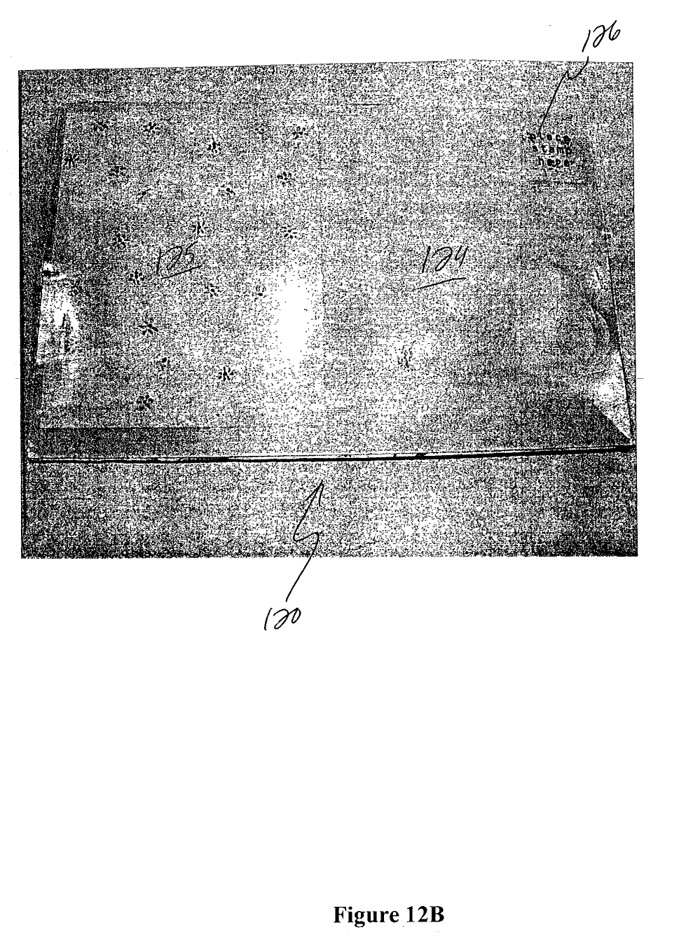

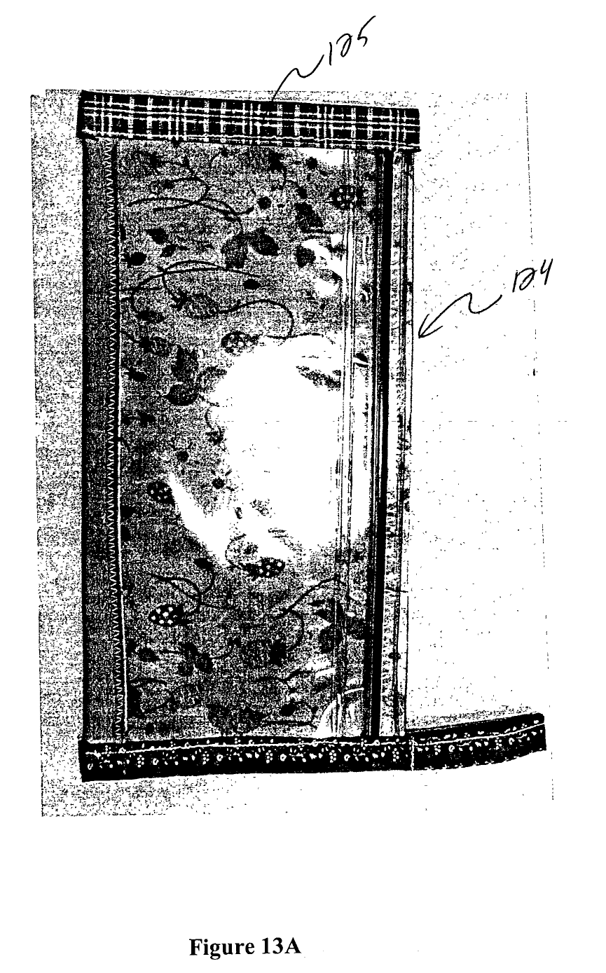

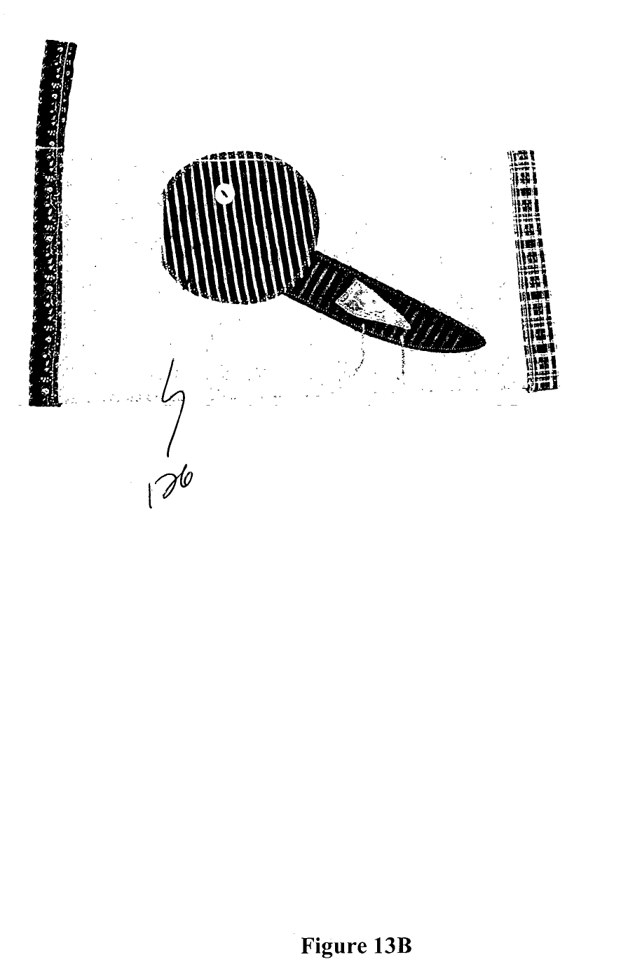

FIGS. 7A and 7B depict a greeting article 70 in the shape of a duck having a thickness of about ⅛ inch and similarly comprised of an integral layer of molded foam polymer 71, such as polyvinylchloride. Alternately, the article can be made of a vinyl-encased foam or other suitable materials. FIGS. 8A and 8B depict a greeting article 80 in the shape of a heart having a thickness of about ⅛ inch and comprised of a vinyl-encased liquid 81 and a thermometer structure 82 which enclosed a colored fluid that simulates mercury. FIGS. 9A and 9B depict an cardstock insert 90 for the pouch article of FIGS. 13A AND 13B. The insert 91 has a message area 91, an address area 97, and a postage area 98. FIGS. 10A and 10B depict a greeting article 100 comprised of two heavy card stock panels 101, 102 enclosing a mesh screen 103, the article having a thickness of about 1/32-1/16 inch. FIGS. 11A and 11B depict a greeting article 110 comprised of a card-stock panel 113, fabric cut-outs 111, and clear polymeric film 112 stitched on to the panel. The stitches define a pocket 115 for each fabric button 111. The article has thickness of about ⅛ to ¼ inch and greeting area 114, address area 116 and postage area 117. FIGS. 12A and 12B depict a greeting article in the form of a facial tissue dispenser 120 having a clear film window 121 that includes a dispensing slit 122. The article contains facial tissues 123 and has a thickness of about ⅛ to ¼ inch. The article also includes an address area 124, a greeting area 125, and a postal area 126. FIGS. 13A and 13B depict a greeting article in the form of a polymeric zipper-type pouch 124 having fabric edge piping 125 and backing 126. The article has thickness of about ⅛ to ¼ inch. The cardstock enclosure depicted in FIGS. 9A and 9B can be advantageously disposed in the pouch article of FIGS. 13A-B.

The foregoing embodiments can be manufactured by producing the greeting articles according to known printing an assembly techniques, weighing at least one exemplar to determine the appropriate postage, and then printing a plurality of the greeting articles with a pre-paid postage meter device such as those commercially available from Pitney Bowes of Stamford, Conn.

The foregoing articles can be modified in many respect in according to the teachings set forth herein. For instance, any desired dimension or configuration can be used, including generally cubical or spherical configurations. The articles need not have a generally planar construction, although in certain embodiments such a configuration can ease inscription of address and greeting information.

Any number of decorative elements can be formed integrally with, affixed to, or be disposed wholly or partially within the article, including without limitation textiles, plastics, wooden objects, metal ornamentation, fasteners and the like.

The greeting, address, and/or postage areas need not be integral with the greeting article. For example, these indicia may be inscribed on separate adhesive labels that are applied to the greeting article by the consumer before shipment.

As will be appreciated from the foregoing description and drawings, the articles include greeting areas at least about 1 inch by 1 inch, preferable at least about 2 inches by 2 inches, and more preferably at least about 2 inches by 4 inches.

The greeting articles may be adapted to have any number of secondary utilities additional to the hot pad, coffee holder, and coaster embodiments depicted and described above. For example, the greeting articles may have a multi-piece, hinged construction that serves as a hinged picture frame.

In certain embodiments pre-paid postage stamps printed on the greeting articles. In other embodiments, other postage related indicia, such as instructions concerning the appropriate postage, may be disposed on the article.

In the preferred constructions, the greeting articles are adapted to be shipped without an envelope. Accordingly, the articles can advantageously be constructed of coated cardstock or polymeric materials which are receptive to ink and which will absorb the ink to an extent which prevents significant smearing of the ink during shipment or handling. Optionally, however, many of the constructions described herein can be mailed inside an envelope if desired.

Certain embodiments discussed herein have a weight greater than 1 oz., the weight limit for regular letter postage. In such circumstances, the extra weight will incur additional postage over and above any postage surcharge associated with the dimensions of the article.

A number of embodiments of the present invention have been described. Nevertheless, it will be understood that various additional modifications may be made without departing from the spirit and scope of the invention.

What is claimed is:

1. A mailable greeting article comprising:
a three dimensional mailer wherein each dimension is at least about ⅛ inch and wherein the mailer is adapted to be mailed without an envelope;
a greeting indicium disposed on an exterior surface of the mailer demarking an area adapted to receive an inscribed greeting;
an address indicium disposed on an exterior surface of the mailer demarking an area adapted to receive an inscribed address; and
a pre-paid postage indicium disposed on an exterior surface of the mailer, wherein the postage indicium reflects payment of postage sufficient for mailing the three dimensional mailer.

2. The article of claim 1, wherein the mailer is comprised of a plurality of members adjoined by adhesives, threads or mechanical fasteners.

3. The article of claim 1, wherein each dimension is at least about ¼ inch.

4. The article of claim 1, wherein the mailer is adapted to endure shipment without significant visible wear.

5. The article of claim 1, wherein at mailer is generally planar.

6. The article of claim 1, wherein the greeting and address indicia are selected from the group consisting of a line, text segment, and a score.

7. The article of claim 1, wherein areas demarked by the greeting and address indicia are adapted to receive ink hand inscriptions.

8. The article of claim 7, wherein the areas demarked by the greeting and address indicia are adapted to retain an inscription without substantial smearing during handling.

9. The article of claim 1, wherein the greeting, address or postage indicium is imprinted upon a label affixed to the mailer.

10. The article of claim 1, wherein the area adapted to receive an inscribed greeting is at least about 2 inches by 2 inches.

11. The article of claim 1, wherein the mailer has a plurality of sides and the greeting and address indicia are on different sides and wherein the address and postage indicia are on the same side.

12. The article of claim 1, wherein the postage pre-paid indicator comprises a postage meter stamp.

13. The article of claim 1, wherein the mailer comprises a printed circuit.

14. The article of claim 1, wherein the mailer includes a plurality of ornamental elements adjoined to one or more base members.

15. The article of claim 1, wherein the mailer comprises three or more ornamental elements adjoined to one or more base members.

16. The article of claim 1, 2, 3, 4, 5, 6, 7, 8, 9, 10, 11, 12, 13, 14, or 15, wherein the mailer weighs more than one ounce.

17. A mailable greeting article comprising:
a three dimensional mailer wherein each dimension is at least about ⅛ inch and wherein the mailer is adapted to be mailed without an envelope;
an address indicium disposed on an exterior surface of the mailer demarking an area adapted to receive an inscribed address; and
a pre-paid postage indicium disposed on an exterior surface of the mailer, wherein the postage indicium reflects payment of postage sufficient for mailing the three dimensional mailer.

18. The article of claim 17, further comprising a greeting indicium disposed on an exterior surface of the mailer demarking an area adapted to receive an inscribed greeting.

19. The article of claim 17, wherein each dimension is at least about ¼ inch.

20. The article of claim 17, wherein the mailer is adapted to endure shipment without significant visible wear.

21. The article of claim 17, wherein at mailer is generally planar.

22. The article of claim 17, wherein the address indicium is selected from the group consisting of a line, text segment, and a score.

23. The article of claim 17, wherein the area demarked by the address indicium is adapted to receive ink hand inscriptions.

24. The article of claim 23, wherein the area demarked by the address indicium is adapted to retain an inscription without substantial smearing during handling.

25. The article of claim 17, wherein the postage pre-paid indicator comprises a postage meter stamp.

26. The article of claim 17, wherein the mailer comprises a printed circuit.

27. The article of claim 17, wherein the mailer includes a plurality of ornamental elements adjoined to one or more base members.

28. The article of claim 17, wherein the mailer comprises three or more ornamental elements adjoined to one or more base members.

29. The article of claim 17, 18, 19, 20, 21, 22, 23, 24, 25, 26, 27, or 28, wherein the mailer weighs more than one ounce.
